(19) United States
(12) Patent Application Publication
(10) Pub. No.: US 2013/0263926 A1
(43) Pub. Date: Oct. 10, 2013

(54) SYSTEMS AND METHODS FOR FLUID CONVEYING AND/OR HEATING

(71) Applicants: Lee H. Stellmacher, Ripon, WI (US); Brock E. Stellmacher, Ripon, WI (US)

(72) Inventors: Lee H. Stellmacher, Ripon, WI (US); Brock E. Stellmacher, Ripon, WI (US)

(21) Appl. No.: 13/860,219

(22) Filed: Apr. 10, 2013

Related U.S. Application Data
(60) Provisional application No. 61/622,350, filed on Apr. 10, 2012.

(51) Int. Cl. F17D 1/14

(52) U.S. Cl. CPC F17D 1/14
USPC 137/1; 137/123; 137/565.17; 137/561 R

(57) ABSTRACT

Systems and methods of fluid conveyance and/or heating are provided. A system according to the present invention provides improved selected localized or distributed fluid heating, master/slave dual pump control, hose construction, and/or a combination thereof. Another system according to the present invention provides a portable plural fluid heating apparatus, which may be located closer to a fluid application point than a fluid source, thereby minimizing the distance required to be traveled by fluid after heating.

### RELATED APPLICATION

This application claims the benefit of Provisional patent application Ser. No. 61/622,350 filed 10 Apr. 2012.

### BACKGROUND OF THE INVENTION

Embodiments according to the present invention relate generally to fluid handling, and more particularly to multi-component fluid handling and heating. Plural-component fluid handling is common in applications such as spray elastomers, which may be used in spray coating applications, such as spray foam insulation (e.g., polyurethane (isocyanate and resin)), polyurea coatings, polyethylene, polyaspartic (e.g. polyisocyanate and polyaspartic ester), polyurethane/urea foams, etc. Fixed-ratio, dual component proportioners have been known for many years. In fact some prior component proportioners have even included heating elements so as to heat fluid prior to mixing so as to desirably adjust fluid viscosity to provide a more thorough mixture for spraying or other application.

There remains room for improvement in the art of fluid handling, and especially in the art of plural component fluid handling prior to mixture, such as improved selective heating, dual pump control, hose construction, and/or a combination thereof.

### SUMMARY OF THE INVENTION

Systems and methods according to the present invention provide improved selective heating, dual pump control, hose construction, and/or a combination thereof.

### BRIEF DESCRIPTION OF THE DRAWINGS

FIG. 1 is a top plan view of a first embodiment of a system according to the present invention.

FIG. 2A is a diagram of an embodiment of a fluid flow path according to the present invention.

FIG. 2B is a cross-section view taken along lines 2B-2B of FIG. 2A.

FIG. 2C is a cross-section view taken along lines 2C-2C of FIG. 2A.

FIG. 3 is an electrical schematic of an embodiment of a control panel according to the present invention.

FIG. 4 is a partial perspective view of the system of FIG. 1.

FIG. 5 is a partial front elevation view of an embodiment of a user interface according to the present invention.

FIG. 6A is a perspective view of an embodiment of a portable fluid heater according to the present invention.

FIG. 6B is an internal top plan view of the embodiment of FIG. 6A.

FIG. 7 is an electrical schematic of the embodiment of FIG. 6A.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

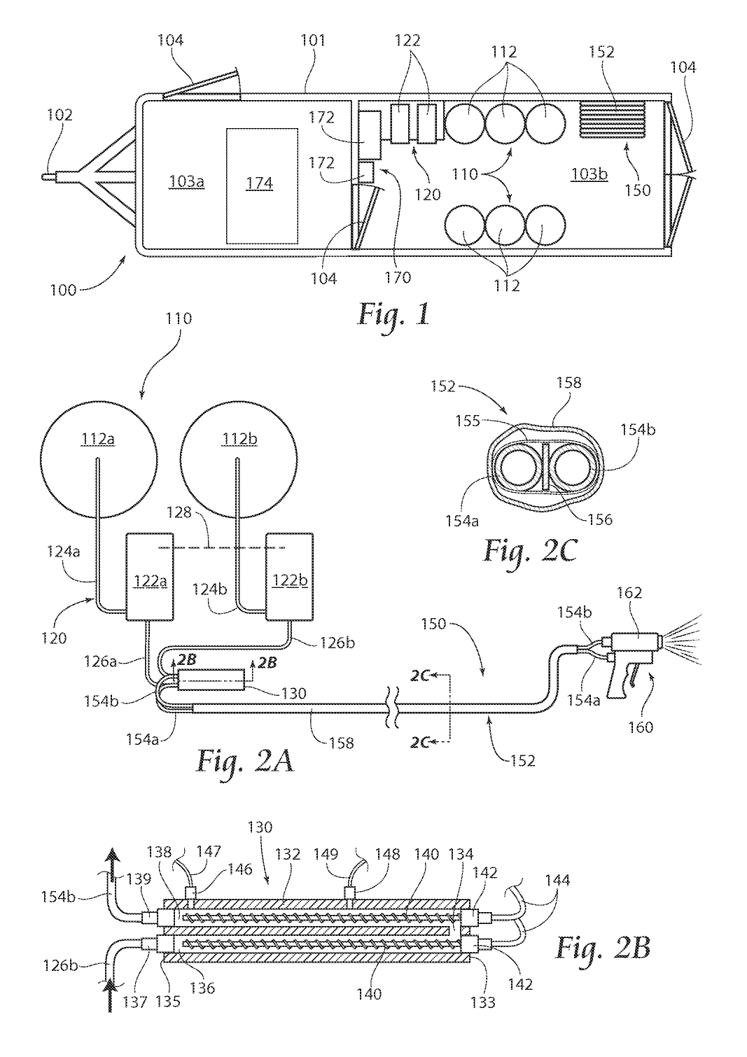

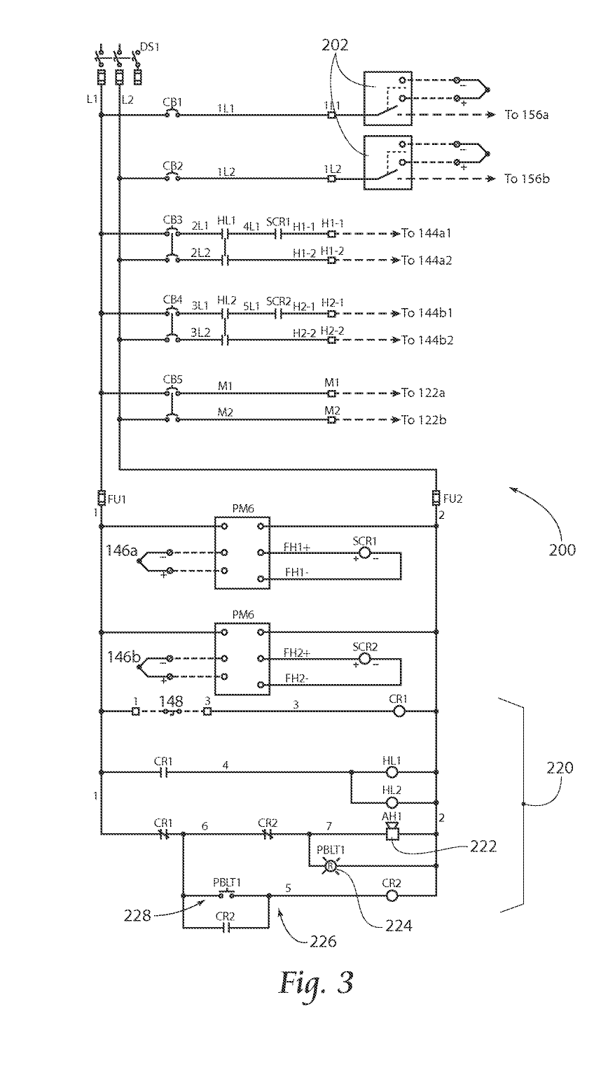

Turning now to the figures, FIG. 1 provides a plan view of a fluid handling system 100 according to the present invention. Also with reference to FIG. 2A, generally, the preferred system 100 includes a fluid supply 110, a fluid distribution system 120, a fluid conveyor 150, and an electrical operational interface 170. The fluid supply 110 comprises at least one, but preferably a plurality of fluid vessels 112, each of which may include a siphoning mechanism (not shown), as is known in the art for drawing fluid therefrom. The fluid distribution system 120 generally includes at least one, but preferably a plurality of pumps 122, each of which is in fluid communication with a fluid vessel 112. The fluid conveyor 150 generally comprises at least hose 152, which may include one or more conduits 154 each configured to receive fluid from a pump 122, and a nozzle 160. The electrical operational interface 170 may comprise one or more electrical component cabinets 172, through which electricity flows from a generator 174 or power mains, is controlled, and then delivered to various electrical components, as explained further below. The system 100 may be housed in a movable shell, such as an enclosed trailer 101, disposed on one or more wheeled axles (not shown). The trailer 101 preferably includes a hitch mechanism 102 configured to mechanically cooperate with a ball hitch or hitch receiver member coupled to a motorized vehicle for easy transport. The trailer 101 may have a plurality of internal cavities 103a,b, each of which may be accessed by one or more manway doors 104.

Turning now to FIGS. 2A-2C, a fluid flow path through an embodiment of a system according to the present invention may be explained. Generally, the system is configured to transport fluid from the fluid supply 110 to the nozzle 160. In a preferred embodiment, as shown, the system may be configured to convey a plurality of fluids, each from a separate fluid supply vessel 112a,b, to the nozzle 160, such as a plural component mixing gun 162. In the preferred embodiment, a first pump 122a has an input line 124a in fluid communication with a first fluid vessel 112a. The first pump 122a has an output line 126a, which may form a component of the fluid conveyor 150, or as shown, may convey the fluid from the first vessel 112a to a primary fluid heater 130. A second pump 122b has an input line 124b in fluid communication with a second fluid vessel 112b. The second pump 122b has an output line 126b, which may form a component of the fluid conveyor 150, or as shown, may convey the fluid from the second vessel 112b to the primary fluid heater 130. The first pump 122a and the second pump 122b may be operated separately, but advantageously are operated in a master/slave configuration 128, whereby blend ratios of a plurality of fluids may be controlled from a single pump control panel.

As shown, in a preferred system, a plurality of fluids is conveyed through a primary fluid heater 130 prior to being presented to the fluid conveyor 150. The primary heater 130 preferably includes an aluminum parallelepiped heater body 132 including at least one, but preferably a plurality of parallel U-shaped heating cavities 134, extending between a first control end 133 and a second fluid end 135 thereof. On the fluid end 135 of the heater body 132, each heating cavity 134 has an input end 136 in fluid communication, such as through a quick-connect fitting 137, with a pump output line 126, and has an output end 138 in fluid communication, such as through a quick-connect fitting 139, with a fluid conveyor conduit 154. Most preferably, the input end 136 and output end 138 of each heating cavity is provided on the fluid end 135 of the heater body 132 to provide easy fluid connectivity access. The fluid is heated within the heating cavities 134 by electrically resistive heating elements 140, which are electrically coupled to the electrical operational interface 170 through connectors 142 and/or wires 144. Disposed in fluid communication with preferably each heating cavity 134 is a thermocouple 146 or other temperature sensor or transducer, which may be used to generate an electrical representation of the temperature, or an approximation of the temperature, of the respective fluid. The thermocouple 146 preferably extends through an aperture formed through a surface of the heater body 132 and into the output end 138 of a cavity 134. The thermocouple 146 is electrically coupled to the electrical operational interface 170 through connectors and/or wires 147. A heater body thermocouple 148 may also be provided, to enable the measurement or approximation of the temperature of the heater body 132 for safety reasons. The heater body thermocouple 148 is electrically coupled to the electrical operational interface 170 through connectors and/or wires 149.

A cross-section of a preferred fluid conveyor hose 152, which runs for at least fifty feet, but more preferably about 200 feet, may be seen in FIG. 2C. The hose 152 preferably includes a first fluid flow conduit 154a and a second fluid flow conduit 154b, generally secured by an adhesive conduit jacket 155 extending therearound. Conventionally, in prior plural conduit hoses, the conduit jacket is structurally bonded to the plurality of conduits, thus rendering it nearly impossible to change a single conduit in the event of failure (e.g., cracking or bursting) or clogging. For instance, some fluids that may be conveyed with systems according to the present invention may react with air or oxygen so as to form a solid material. If hoses are not properly cleaned after use, air or oxygen may eventually permeate the hose or enter at fitting locations and clog such conduits. In such event, in prior hoses, the entire hose including a plurality of conduits had to be disposed of, while only a single one of the multiple conduits may have been compromised. By providing an adhesive conduit jacket 155 according to this embodiment according the present invention, such as an adhesive tape, the conduit jacket 155 may be easily removed and a single conduit 154 may be replaced upon failure or clogging, rather than requiring disposal of the entire hose. Other easily removable conduit jackets 155 may likewise be utilized, preferably along a majority of the length of the hose 152, or at discrete locations along the hose 152.

Extending completely circumferentially around the conduit jacket 155 is preferably a scuff jacket 158, which may be formed from a woven tubular plastic material. The scuff jacket 158 may be secured at each end thereof to the conduits 154, the conduit jacket 155, or both. In addition to or alternatively to the primary fluid heater 130, a secondary fluid heater may be utilized. In the depicted embodiment, the secondary fluid heater comprises one or more heat tape lengths 156 preferably sandwiched between the fluid flow conduits 154 and generally held in respective position thereto by the conduit jacket 155 previously described. If a plurality of heat tape lengths 156 are provided, they are preferably disposed in a serial arrangement (i.e., end-to-end) to allow for selective heating control along portions of the hose 152.

FIG. 3 provides an electrical schematic of a heating control circuit 200 according to the present invention. Generally, so long as the heater body thermocouple 148, which may be or be connected to a temperature activated switch, is sensing a normal heater body operating temperature (i.e. not too hot), then the contactor CR1 will be activated, thereby providing electrical power therethrough, and also through circuit breakers CB3 and CB4 to the heating elements 140 in the primary heater 130. The heating elements 140 are gated with power, such as by one or more proportional-integral-derivative (PID) controllers PM6, which receive input from the fluid thermocouples 146. Each PID controller then respectively turns a solid state relay SCR1,2 on and off as needed to supply power to the wires 144 electrically coupled to the heating elements 140. A preferred PID controller is an EZ-ZONE® PM Express PID Controller available from Watlow Winona, Inc. of Winona, Minn.

The circuit 200 also preferably provides circuit breaker protected power to the pumps 122 and to secondary heater controllers 202. The secondary heater controllers 202 preferably receive temperature feedback from the hose 152, thereby gating power its respective heat tape length 156. A preferred secondary heater controller 202 is an A419 Series Electronic Temperature Control available from Johnson Controls, Inc., of Milwaukee, Wis.

The circuit 200 is also preferably provided with a safety circuit 220, which may be activated by the tripping of the temperature activated switch controlled by or as a result of the heater body thermocouple 148. The safety circuit 220 generally operates as follows. If the temperature activated switch opens, then CR1 is deactivated, which means power is removed from the heater lines HL1,2, regardless of the demand for heat from the PID controllers. Warning indicators such as a horn 222 and a light 224 may be activated, and a latching circuit 226 may be provided to allow clearing of one or both of the warning indicators. As shown, upon depression of a normally open push button switch 228, CR2 is activated, thereby disconnecting the horn 222 and light 224. Alternatively, the light 224 may be connected on the other side of CR2, such that the button 228 clears only the horn 222, and the light 224 remains lit until the warning situation is cleared by the heater body thermocouple 148. Once the temperature activated switch senses a normal (i.e. low enough) heater body temperature through the heater body thermocouple 148, then CR1 is reactivated and the warning condition is cleared. The circuit 200 is preferably provided in or supported on at least one wiring panel 172. However, in some circumstances it may be desirable to, for instance, separate the circuit breakers into a wiring panel of their own.

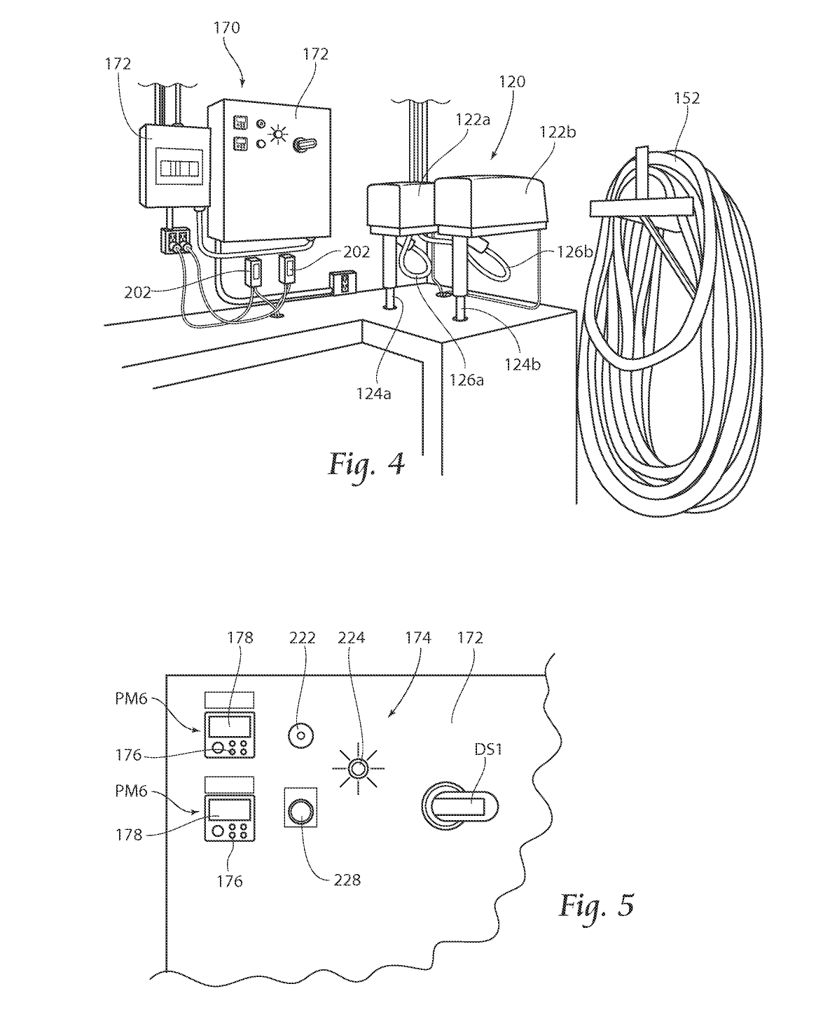

FIG. 4 generally provides an elevation view of an arrangement of the system of FIG. 1.

FIG. 5 depicts a preferred electrical system user interface 174 according to the present invention. The user interface 174 preferably includes user input devices, such as buttons 176 on the PID controllers PM6, the warning clearing button 228, and a main disconnect switch DS1. The user interface 174 further preferably includes user output devices such as visual displays 178 on the PID controllers PM6, the warning horn 222, and the warning light 224.

In use, a fluid path is established between a fluid supply vessel 112 and a pump 122, and between the pump 122 and a nozzle 160. The pump 122 draws fluid from the fluid supply vessel 112 and delivers it at a desired pressure to the nozzle 160. In a preferred use, two fluid supply vessels 112a,b each is coupled to a separate pump 122a,b, respectively. From the pumps 122a,b, one or both fluids are fed through a primary heater 130, through a length of conduit 152 and to the nozzle 160 in or at which the fluids are mixed just prior to or during spraying or other application. Even more preferably, the conduit 152, which may have a plurality of distinct fluid flow paths, is heated along at least a portion of its length. Indeed, separate portions of the conduit 152 may be heated, such as by heat tape sections 156, which may be placed in a longitudinally serial manner along the conduit 152. In this manner, each fluid may be selectively heated to approximately a desired temperature within the primary heater 130, and/or both fluids may be heated to approximately a desired temperature in the conduit 152 by one or more heat tape sections 156. A desired fluid temperature may be programmed into the respective PID controller PM6 for each fluid, a desired fluid temperature may be programmed into the secondary heater controllers 202 for one or more tape section 156 provided, and a desired fluid pressure may be programmed into or selected on each pump 122. The fluid pressure may be selected individually, or one of the pumps may control the second pump as a slave device. If in a master/slave control arrangement, the master pump may have preprogrammed modes of operation to enable preset mixtures of the fluids, where such preset mixtures may depend upon the nature or type of the fluids to be mixed, ambient temperature, ambient humidity, and/or distance from pump to fluid application location.

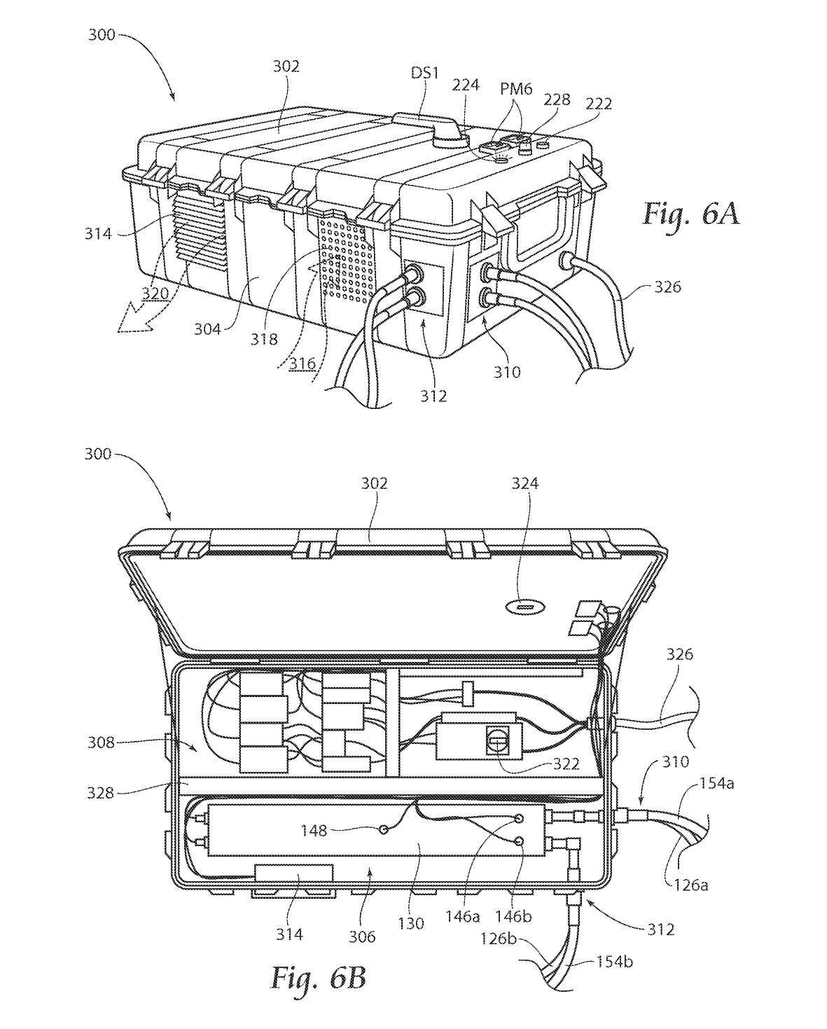

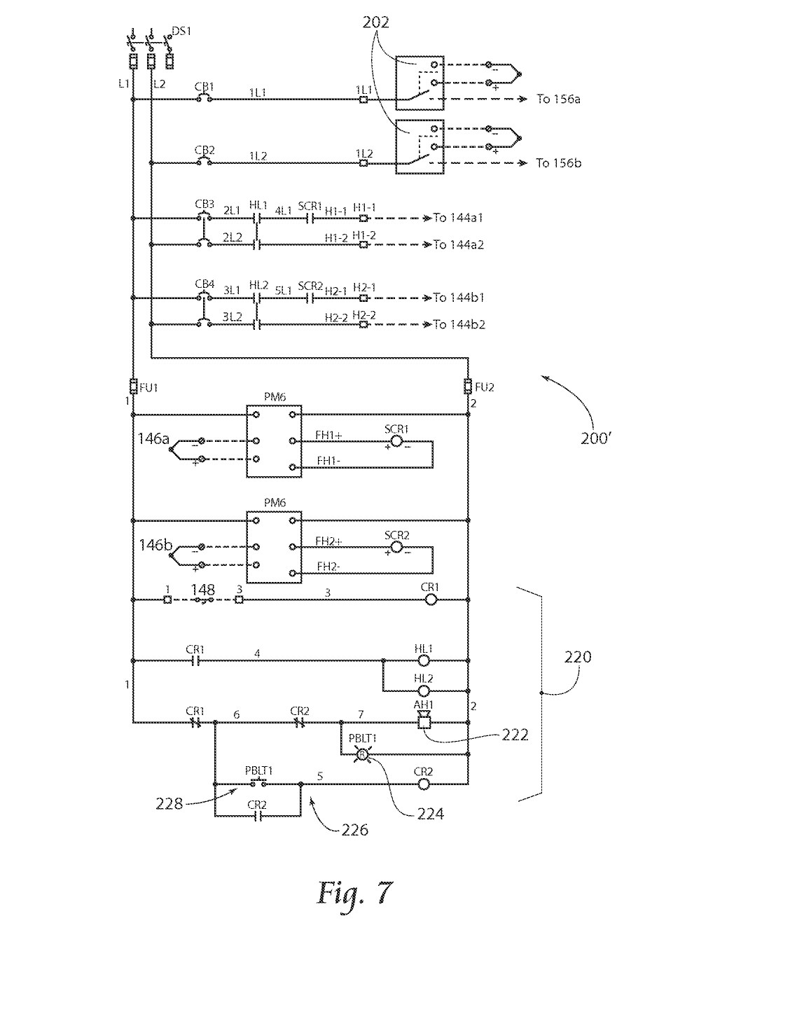

It is to be understood that the primary heating system (primary heater 130 plus control circuitry) described thus far is mounted in a stationary wiring cabinet 172 that may be mounted in a movable trailer unit 101. However, it may be desirable to provide a portable primary heating unit, such that the primary heating is performed at a location remote from (outside of) the structure that otherwise houses a fluid supply and/or fluid distribution mechanism or pump. An embodiment of a portable or remote fluid heating system 300 is shown with reference to FIGS. 6A-7, where like reference numerals refer, in at least utilitarian terms, to the same or similar structure to the system 100 described above. The system 300 generally includes a container having a lid 302 mateable to a base 304. The base 304 preferably defines at least one cavity, but preferably at least a heating cavity 306 and a control cavity 308. Disposed within the heating cavity 306 is a primary heater 130, as previously described. Access to fluid inputs and outputs of the heater 130 may be provided through a first fluid interface 310 and a second fluid interface 312. While various configurations are possible, the fluid interfaces 310, 312 are preferably provided on two different faces of the base 304, preferably at about ninety degrees to each other, proximate to a corner of the base 304. Each fluid interface 310, 312 may be respectively color coded (e.g. one red and one blue) to enhance connection reliability. Extending through a wall of the base 304 and into the heating cavity 306 is a fan assembly 314. The fan assembly 314 draws outside air into the heating cavity 306 in a first direction 316 through one or more apertures 318 formed through the wall of the base 304, and blows heated air out of the heating cavity 306 in a second direction 320 that is substantially opposite the first direction 316.

In the control cavity 308 are preferably mounted some of the electrical components of the circuit of FIG. 7. The disconnect switch DS1 provided on the outside of the cover 302 operates through a mechanical cooperation of a male member 322 and a female member 324 to enable rotation of the switch. Power is supplied to the electrical components through an electrical cable 326, which is coupled to a power supply, which may provide power that is locally generated or supplied via standard power mains.

Fixedly situated between the heating cavity 306 and the control cavity 308 is an insulation barrier 328, which preferably extends through an entire height of the heating cavity 306 so as to shield the electrical components from excessive ambient heat from the primary heater 130. Additionally or alternatively, a second fan assembly (not shown) may be arranged so as to vent the control cavity 308 similar to how the fan assembly 314 vents the heating cavity 308.

The circuit schematic provided in FIG. 7 is identical to the schematic in FIG. 3, without the power feed to the fluid distribution system 120. Additionally, the circuitry related to the secondary heater controllers 202 may be removed if desired. A secondary fluid heater, such as the heat tape sections 156 may not be required in conjunction with the portable heater system 300 of FIG. 6A because the heater may be located and used proximate to a fluid application point, thereby shortening the distance required to be traversed by the fluid conduit 152. That is, if fluid is heated in a trailer, or closer to a fluid supply than to a fluid application location, a generally recognized conduit length is about 200 feet. However, if a portable heating system 300 is used, and located closer to the fluid application location than the fluid supply, then a shorter hose, such as 20 feet to about 50 feet may be used, thereby potentially eliminating the need for any secondary heating requirement.

In use, the portable heating system 300 may be located closer to the fluid application location than the fluid supply. Fluid supply inputs at a desired pressure may be coupled to respective inputs on the fluid interfaces 310, 312, and the outputs may be placed in fluid communication with a fluid flow conduit 152. Like with the system 100 described above, a desired fluid temperature may be programmed into the respective PID controller PM6 for each fluid, a desired fluid temperature may be programmed into the secondary heater controllers 202, if provided, for one or more tape section 156 provided, and a desired fluid pressure may be programmed into or selected on each pump 122. The fluid pressure may be selected individually, or one of the pumps may control the second pump as a slave device. If in a master/slave control arrangement, the master pump may have preprogrammed modes of operation to enable preset mixtures of the fluids, where such preset mixtures may depend upon the nature or type of the fluids to be mixed, ambient temperature, ambient humidity, and/or distance from pump to fluid application location.

The foregoing is considered as illustrative only of the principles of the invention. Furthermore, since numerous modifications and changes will readily occur to those skilled in the art, it is not desired to limit the invention to the exact construction and operation shown and described. For instance, while the system has been described with respect to usage with at least one and preferably two fluids, it is to be understood that such usage is exemplary, and more fluids may be utilized. While the preferred embodiment has been described, the details may be changed without departing from the invention.

1. A fluid handling system including:
a fluid supply;
a fluid distribution system;
a fluid conveyor; and
an electrical operational interface.

2. The fluid handling system of claim 1 wherein the fluid supply comprises at least one fluid vessel.

3. The fluid handling system of claim 1 wherein the fluid supply comprises a plurality of fluid vessels.

4. The fluid handling system of claim 2 wherein the at least one fluid vessel includes a siphoning mechanism.

5. The fluid handling system of claim 2 wherein the fluid distribution system includes at least one pump.

6. The fluid handling system of claim 2 wherein the fluid distribution system includes a plurality of pumps.

7. The fluid handling system of claim 5 wherein the at least one pump is in fluid communication with a fluid vessel.

8. The fluid handling system of claim 7 wherein the fluid conveyor includes a hose having at least one conduit configured to receive fluid from a pump.

9. The fluid handling system of claim 1 wherein the electrical operational interface includes at least one electrical component cabinet through which electricity flows from a power source.

10. A method of fluid handling including the steps of:
providing a fluid supply vessel;
providing a pump;
providing a fluid path between the fluid supply vessel and the pump;
providing a nozzle;
providing a fluid path between the pump and the nozzle;
drawing a fluid along the fluid path from the fluid supply vessel;
moving the fluid along the fluid path to the nozzle.

11. The method of claim 10 further including the steps of providing a primary heater and moving the fluid through the primary heater.

12. The method of claim 10 further including the steps of providing a length of conduit and moving the fluid through the conduit.

13. The method of claim 12 further including the step of providing the conduit with a plurality of fluid flow paths.

14. The method of claim 13 further including the step of providing at least a portion of conduit length with heat.
